(19) United States
(12) Patent Application Publication
(10) Pub. No.: US 2010/0121650 A1
(43) Pub. Date: May 13, 2010

(54) SYSTEM AND METHOD FOR CONTENT DEVELOPMENT

(76) Inventors: John M. Hughes, Hebron, CT (US); James DeJulio, Venice, CA (US); Mark Burrell, Santa Monica, CA (US); Robert Salvatore, Santa Monica, CA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/487,874

(22) Filed: Jun. 19, 2009

Related U.S. Application Data
(60) Provisional application No. 61/075,175, filed on Jun. 24, 2008.

(51) Int. Cl. G06Q 30/00; G06Q 99/00

(52) U.S. Cl. 705/1.1

(57) ABSTRACT

Media content is developed using a competition model and supporting computerized systems. Multiple competition phases may be held to generate content throughout the creative process from idea to completed project. Prizes are awarded to the competitors that create winning submissions and the reuse of submissions.

### CROSS-REFERENCE TO RELATED APPLICATION(S)

This application claims priority to and the benefits of U.S. provisional patent application Ser. No. 61/075,175, filed Jun. 24, 2008, the entire disclosure of which is incorporated herein by reference.

### TECHNICAL FIELD

This invention relates generally to methods and systems for facilitating content development, and, more specifically, to techniques and supporting computer-based infrastructure and processes for enabling collaborative and/or competitive development of media assets.

### BACKGROUND INFORMATION

Current methods for developing media assets (e.g., video, audio, images, film, etc.) and advertising cost too much and take too long. For example, recent industry publications have said that it takes a minimum of two to three months from conception to finished product to create a professional quality 30-second television advertisement, with a cost of over $500,000. This makes it difficult for many companies to participate, but in addition, the rise of internet video has reduced at least the perceived benefit of this type of advertising.

Furthermore, those tasked with generating the original ideas that evolve into the media assets are often far-removed from those the media will eventually target. Professional marketing executives and research firms spent significant amounts of time and money on studies and focus groups trying to craft messages, media and content they believe will appeal to their audience. However, the time lag and physical disconnect between those producing the content and the intended viewers. Often, by the time fully-produced content is aired or posted, it is stale and no longer interesting.

Recently, lower-cost computing resources, web-based tools and broadband Internet access have given individuals the means to develop and distribute media content almost instantly. So-called “user generated content” (UGC) has become ubiquitous on websites such as YouTube®, Facebook®, and many others. Ironically, it is often the case that video clips, shorts films, how-to films and other UGC obtain greater popularity than professionally produced content. What is needed, therefore, are techniques and supporting systems that tap into the vast community of content developers to produce high-quality media content.

### SUMMARY OF THE INVENTION

A series of progressive, phased contests are used to facilitate the development of media assets such as print (advertisements, logos, etc.) multimedia content (e.g., filmed video, music video, etc.) and conceptual content (ideas, concepts, etc.). Each phase of the competitions represents a stage in the development and production of the content. For example, each competition in the series of competitions may result in one or more “building blocks” in the development and production of a film. Results to be selected from each competition may be judged, for example, by an administrator and/or a sponsor of the contest. As media content elements are selected as winning submissions and used for subsequent phases of the contest, prizes, cash or other recognition may be awarded to the developer(s) that submitted the winning submissions.

Therefore, in a first aspect, the invention provides a system for facilitating the development of a media asset. The system includes a communications server and a contest server. The communications server is configured to communicate information about media asset development contests to a community of developers. The contest server is configured to receive competition parameters (from a sponsor of the contest, for example) and to receive developed media content from the developers. The contest server is also configured to facilitate the review of the submitted media content elements (by, for example, a judge or panel of judges), thereby identifying one or more winning media content elements. The winning media content elements are then communicated back to the community of developers as subject matter for one or more subsequent phases of the contest. As a result, a completed media asset is created.

In some embodiments, the system also includes a payment module configured to allocate payment to developers submitting the winning media content elements, and in some cases payments are based on usage of submitted media content elements in subsequent phases of the contest.

The media asset may be any form of audio and/or video communication, such as a feature film, a television show, an instructional video, a training guide, a music video, a commercial, a print advertisement, a web-enabled video advertisement, a short film, a cartoon, an illustrated book, or a graphic novel. The media content elements that make up the media asset may include, an idea, a unique character, a slogan, a script, a storyline, a media file and/or a pitch.

In some embodiments, the system also includes a voting module configured to present media content elements to members of the community and receive feedback on the media content elements from the community. The feedback may, in some cases, include a prediction of how well the media content element will place in the contest. In implementations that include the payment module, payments may also be allocated to members of the community who accurately predict results of the contest.

The system may also include one or more client devices. The client devices may be used to participate in the contest, develop and/or review media content elements and assets, and in some cases facilitate entry of the media asset development contest information that define the parameters of the contest. The system may also include a database module for storing the media asset development contest information, the media content elements, and the media assets.

In another aspect, the invention provides a method for developing a media asset that is based on one or more media content elements, such as an idea, a script, a storyline, a media file and/or a pitch. The media assets may be any form of audio and/or video communication, such as feature films, television shows, instructional videos, training guides, music videos, commercials, print advertisements, web-enabled video advertising, short films, cartoons, illustrated books, graphic novels, graphic designs, product/packaging designs, unique characters, taglines and slogans, marketing and promotional ideas and concepts, product names, or public service announcements.

The method includes the steps of receiving, at a contest server, contest information defining parameters of a media asset creation contest that includes multiple contest phases. Each phase results in the creation and identification of one or more winning content elements. The contest information and a media content element is transmitted to members of a development community (who, in many cases, are unaffiliated with each other) via a communications server. In response, subsequent contest elements based on the transmitted media content elements are received and scored to determine winning content elements. The process is repeated for each phase until a completed media asset is determined.

The contest information may be provided by a sponsor of the contest, or, in some cases determined by an administrator. In such cases, the members of the community are typically not affiliated with the sponsor or the administrator, other than having registered as members of the community.

In some embodiments, payments may be allocated to members of the community based on results of the contest, such as the extent to which a members' submission is used in subsequent phases of the contest. In certain versions, the method also includes presenting the media content elements to members of the community and receiving feedback on the media content elements. The feedback may, for example, include a prediction of how well the media content element will place in the contest.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of a media content creation, competition, and distribution platform and the environment in which it operates according to an embodiment of the invention.

FIG. 2 is a flowchart illustrating, at a summary level, the phases of a contest-based media content development process according to various embodiments of the invention.

FIGS. 3A and 3B is a more detailed flowchart illustrating the roles and steps of a contest-based media content development process according to various embodiments of the invention.

FIG. 4 is a flowchart illustrating, generally, the payment processes of a contest-based media content development process according to various embodiments of the invention.

### DETAILED DESCRIPTION

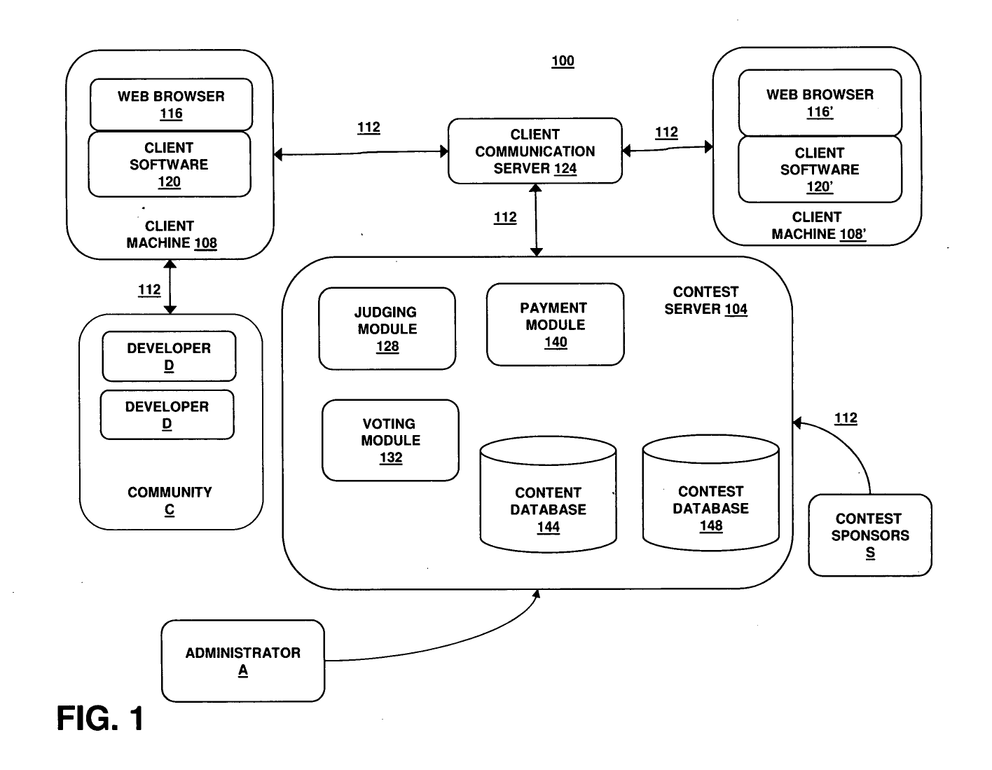

Referring to FIG. 1, in one embodiment, a media content creation, competition, compensation and distribution environment 100 includes at least one contest server 104 and at least one client 108, 108′ (generally 108) communicating over one or more networks 112. As shown, the environment 100 includes two clients 108 and 108′, for exemplary purposes, however it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the OSX operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 may also be implemented on such hardware as a smart or dumb terminal, network computer, wireless device, personal data assistant, MP3 player, wireless telephone, information appliance, workstation, minicomputer, mainframe computer, or other computing device, that is operated as a general purpose computer, or a special purpose hardware device used solely for serving as a client 108 in the environment 100. In some instances, the client 108 may also be a hand-held device that communicates with the server 112 wirelessly (or wired), such as mobile telephone, hand-held camera, personal data assistant, or other similar device.

Generally, in some embodiments, clients 108 are operated and used by developers (“D”) who are part of a community (“C”) of users to create, develop, rate, modify, publicize and distribute media content and compete in content development competitions. In certain implementations, the developers compete at various stages of the development process (described in greater detail below) for prizes and/or recognition. Examples of such activities include, but are not limited to the development of feature films, television shows, instructional videos, training guides, music videos, commercials, print advertisements, web-enabled video advertising, short films, cartoons, illustrated books, graphic novels, graphic designs, product/packaging designs, unique characters, taglines and slogans, marketing and promotional ideas and concepts, product names, public service announcements, and others as described below.

Clients 108 can also be operated by entities that are in need of such content, such as record labels, artists, production companies, networks, consumer product companies and corporations, collectively referred to herein as sponsors “S.” The sponsors S use the system to solicit members of the community to participate in content development competitions on behalf of the sponsor S. In addition, sponsors S may also use the clients 108 to provide licensed content to the system 100 to be used by the developers D along with other content (typically user-generated content, UGC) created by the developers D. Licensed content as used herein may include any audio and/or video content protected by copyright or having other restrictions on distribution and display such as, but not limited to, songs, books on tape, movies, branded content, including advertisements, infomercials, etc. The clients 108 may also be operated by an administrator A acting as an intermediary between the sponsors S and community C. The administrator A is typically responsible for the operations of the platform 100, administration of the rules governing use of the platform, advertising and promoting the content creation competitions.

In various embodiments, the client computer 108 includes a web browser 116, client software 120, or both. The web browser 116 allows the client 108 to request and/or interact with a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered the Mozilla Foundation.

In some embodiments, the client 108 also includes client software 120. The client software 120 provides functionality to the client 108 that allows members of the community C to perform the activities described herein. The client software 120 may be implemented in various forms, for example, it may be in the form of a Java applet that is downloaded to the client 108 and runs in conjunction with the web browser 116, a Flash-based application, or the client software 120 may be in the form of a standalone application, implemented in a multi-platform language such as Java or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface; for example, the client software can be implemented as a “plug-in” to the web browser 116. In some implementations, the client software 120 may be implemented using XML and JavaScript (i.e., AJAX) such that data needed by the client software 120 can be retrieved from the server 104 asynchronously, thus reducing network traffic and bandwidth requirements.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on. Preferably, the network 112 can carry TCP/IP protocol communications and HTTP/HTTPS requests made by the web browser 116, and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired Ethernet-based intranet, a local or wide-area network (LAN or WAN), and/or the global communications network known as the Internet, which may accommodate many different communications media and protocols.

The server 104 interacts with the clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device, the amount of content stored and created using the system and the number of users and the size of the user base. For example, the server 104 may be or may be part of a logical group of one or more servers such as a server farm or server network. As another example, there could be multiple servers 104 that may be associated or connected with each other, or multiple servers operating independently and/or as virtualized servers, but with shared data. In a further embodiment and as is typical in large-scale systems, application software may be implemented in components, with different components running on different server computers, on the same server, or some combination. In certain implementations, the functionality of the server may be provided by one or more third-party entities offering such computing services via the Internet in a so-called “cloud-computing” configuration.

In one embodiment, the server 104 and clients 108 enable the administration of contests to create, modify and judge media content by developers D within the community C from licensed content, UGC, and other content. Furthermore, the server 104 can include various functional modules for storing, creating and tracking the media content, contest statistics, payment allocations and other data used to market and administer the environment 100.

More specifically, the server 104 can, in some embodiments, include or interact with a communications server 124 for facilitating messaging and data transfer among the server 104 and the clients 108. For example, the communication server 124 provides a conduit through which the sponsors S upload and track the use of sponsored content and provide instructions and/or guidelines regarding various contest parameters, as described in greater detail below. In some embodiments, the communication server 124 is or operates as part of the server 104 as described above, whereas in other cases the communication server 124 may be a separate server, which may be operated by and/or outsourced to an application service provider (ASP), internet service provider (ISP), or other third-party. Examples of commercially-available software applications that provide such functionality include WebSphere supplied by IBM and Apache supplied by the Apache Foundation.

In some embodiments, the server 104 may also include a judging module 128 that facilitates the review, rating and selected of various elements of the media content as developed by members of the community C. These elements may include, for example, ideas, pitches, scripts, storyboards, audio tracks, locations, graphics, video, and any combination of these elements. The judging module permits members of the community, administrators, and/or sponsors to view the various elements, determine which elements (e.g., typically three to five, but possibly more or less) best address the contest parameters and are of the highest quality, and identify the selected elements as “winning elements” of that particular contest phase. The judging module 128 may include, for example, a viewer applet, which permits online viewing of media content. In some implementations, the judging module 128 also includes a scoring sub-module (not shown) that allows judges to assign quantitative scores and/or textual commentary about the content elements.

The server 104 may also include a voting module 132 that tracks and tabulates scores, feedback, and viewership statistics for the content elements and the resulting media content. For example, the server 104 may provide members of the community (or, in some cases, the public) with access to winning content elements and/or completed media or multimedia files. In other cases, the content may be distributed via the communication server 124. In either case, the voting module 132 provides users with the ability to rate the content (e.g., on a scale of 1 to 10), comment on the content, and in some cases re-use or share the content with others.

The server 104 may also include a payment module 140 for initiating and tracking prizes awarded to developers D when their content elements are selected by the judges as winning entries, reused by other members of the community C to create new content elements, viewed, or voted on. In some cases, the payments are made directly from the sponsor S to the developer D, whereas in other instances the payments are processed by the administrator A. The payment module 140 may also track the distribution of the user-created media content among other members of the community and/or the general public, such that each time the content is used, viewed, copied, and/or distributed, additional payments are provided.

In some embodiments, the system may include one or more databases such as a media content database 144 for storing media content (e.g., music files, video, text, etc.) and a contest database 148 for storing information and parameters that define the various media development contests. For instance, the databases 144 and 148 may store information relating to the media content elements and sponsored content such as usage and/or distribution among members of the community C. The databases may also store user information such as user IDs, passwords, preferences (e.g., favorite music, products, etc.) as well as other information. The contest database 148 also provides prize allocation rules and history related to the results of the content development contests. The databases 144 and 148 provide data to the judging module 128, the voting module 132 and/or the payment module 140 as requested. Examples of database server applications that provides such functionality include the MySQL Database Server offered by Sun Microsystems of Mountain View, Calif., the PostgreSQL Database Server offered by the PostgreSQL Global Development Group of Berkeley, Calif., or the ORACLE Database Server offered by ORACLE Corp. of Redwood Shores, Calif.

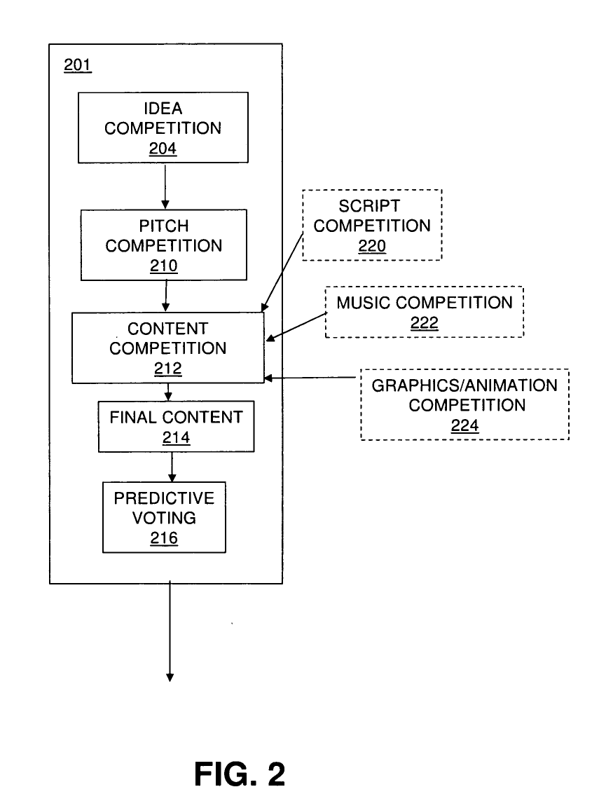

Referring to FIG. 2, in one illustrative example, a process 201 for the development of media content may include multiple phases. At a high level, the process 201 includes multiple competitions aimed at identifying high-quality content elements as developed by members of an online community. More specifically and in one particular embodiment in which the final media content is a feature film, the process 201 may include an idea competition phase 204, a pitch competition phase 210, a content competition phase 212, a final content compilation phase 214 and a predictive voting phase 216. While described the example used herein is a film, it should be understood that any sort of content, with any type of design and production requirements, including without limitation animation, flash content, music, slides, photographs, short films, long films, music videos, screenplays, print advertising, may be suitable for this type of competitive development process.

As described in greater detail below, a series of contests may be held to develop the content. For example, a sponsor may have a concept (e.g., a new movie, an instructional video, a music video, an advertisement for a consumer product, etc.) for which she needs content developed. The starting concept may be, for example, thought-out in detail or more typically only with a high level of description. The starting concept may be simply to create content that includes or illustrates the use of a product or merely a concept that involves marketing a product.

Initially, an idea competition 204 is held. One or more members of the community may compete in the “Idea” phase of a contest by submitting a typed description of an idea (an “Idea Entry”) within certain contest parameters. If, for example, the concept is a new consumer product or service offering, the idea may be a slogan, product name, unique character, trademark or other design to promote the product(s) or service(s). In some cases, there may be a limited amount of time during which an entry may be accepted, a minimum number of submissions required to complete the idea competition 204, and/or a maximum number of submissions accepted. In certain instances, a developer may submit more than one idea entry, whereas in other cases, a developer may be limited to only one submission.

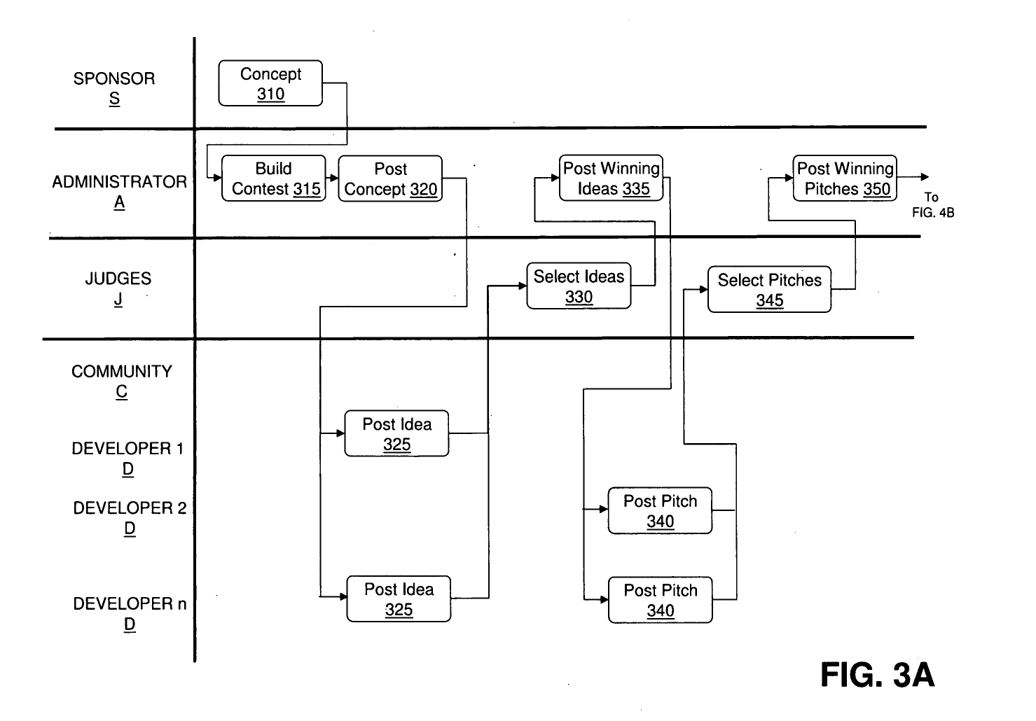

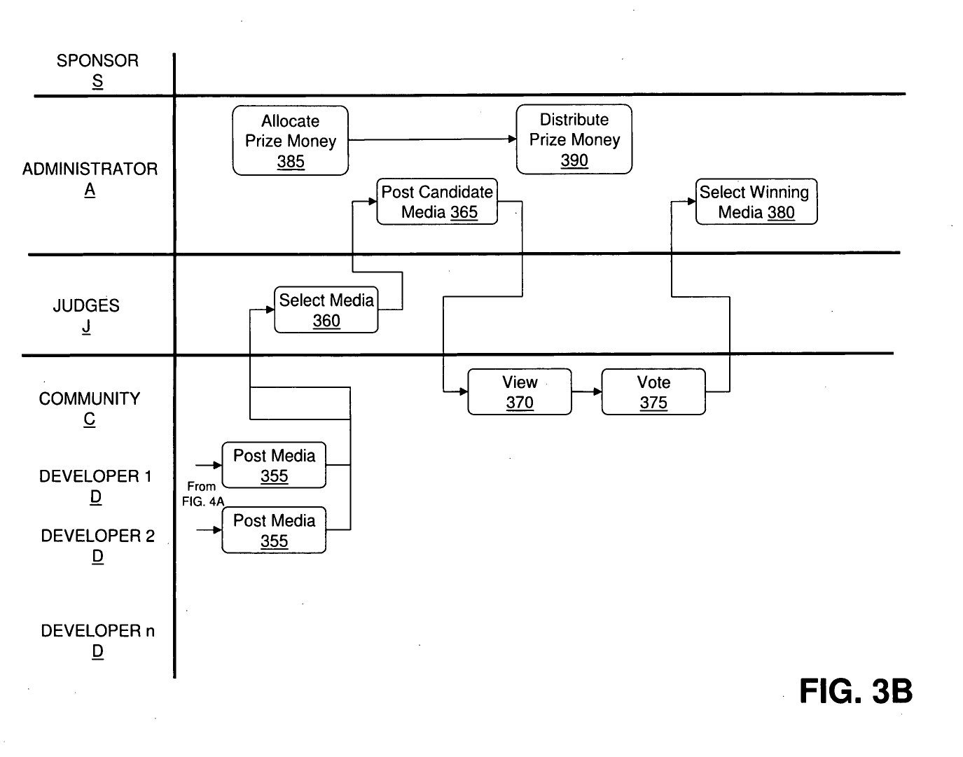

One or more winning ideas are selected (as described in greater detail below with respect to FIGS. 3A and 3B) and may serve as a basis for the pitch competition phase 210. A pitch is typically a short, high-level description of the content. Thus, in the pitch competition 210, developers create a high-level, summary description of a direction to take the project. The developers are provided with the collection of winning ideas, and in some cases the original concept (which may be provided by the sponsor) and other parameters related to the project (e.g., format, budget, etc.). In response to receiving the winning ideas, the developers develop pitches that use, incorporate or build on the ideas. A pitch frequently may be described, for example, in less than 30 seconds, or, for example, in 50-100 words, fewer than 500 characters, or other parameters that limit the length of the pitch. In some cases, developers submit a pitch in text, whereas in some cases, the pitch may include audio, graphic image and/or video.

One or more winning pitches is selected, and a content competition 212 is held to develop the final content 214 based on the winning pitches. The developers assemble the resources that they need (e.g., video, audio, actors, filmmakers, editors, production, etc.) and create the content. In general, it should be understood that the process described in FIG. 2 is but one embodiment, and there may be any number of competitions, different competitions and/or additional competitions. For example, if the desired content is a movie, a script competition 220 may be held to develop scripts based on the pitch. As another example, a music competition 222 may be held, for example to develop or identify theme music to accompany the pitch and/or final content 214. As another example, a graphics or animation competition 224 may be held to identify graphics or animation to go with the final content 214 or be used within the final content 214.

In general, in each stage of the competition, the winner(s) of the competition receive a prize (which may be money, points, goods, services, carried interest in winning submissions, some combination, etc.) in exchange for assigning their rights in the submission to the sponsor. From the point of view of the sponsor, the process and systems provide a development marketplace to develop content according to their needs. From the point of view of the developers, the environment provides an opportunity to gain recognition and receive prize compensation through participation.

In some instances, the sponsor and developers may need to interact with each other during development of the content. Typically, this interaction would take place on a forum such as on a web site hosted by the administrator and implemented on the server, that is open to all of the competing developers. At any stage in the process, if a sponsor is not happy with the results, she may decide to hold additional contest(s), to review or revise the previous work product with new or changed requirements, and so forth.

FIGS. 3A and 3B illustrate the content development contest process in more detail in which the final result is a media product such as a video advertisement. In some embodiments, the content development and contest process is monitored and managed by an administrator A on behalf of a sponsor S. The administrator can be any individual, group, or entity capable of performing the functions described here. In some cases, the administrator can be selected from the distributed community of contestants based on, for example, achieving exemplary scores on previous submissions, or achieving a high ranking in a competition. In other cases, the judges may be appointed or supplied by the sponsor requesting the development, and thus the sponsor can oversee the competition.

The sponsor S of the contest process develops a concept (STEP 310), which may be as simple as a single sentence (“we need to market a new soft drink”) or, in some cases, may include more details about certain parameters. For example, the concept may also include a requirement that the result include both video and audio, play for no longer than thirty seconds, and target a particular demographic. In some embodiments, representatives of a sponsor, and members in different roles, may have access to different capabilities for the project. For example, some sponsor may be able to post concepts and initiate contests, while others may only be able to review status, and others review and approve payments. The sponsor S provides the details of the concept to the administrator A, who builds the contest (STEP 315) based on the concept and parameters. In some cases, the concept may include a list of technical requirements, such as length, format, file types, colors, etc. In some cases the concept may include the result of a previous competition, and so forth. In some cases, the concept may be the result of a previous competition along with a description of requested changes or additions to the content. The administrator A may review the concept, and format or otherwise modify it to conform to standards. The administrator A may himself interact with the sponsor of the competition to obtain further detail or information.

The administrator A may, for example, use the system described above with respect to FIG. 1 as the platform for entering the contest parameters, advertising the contest to members of the community C, recruiting judges J and/or new developers D, administering the contest, and/or allocating prizes to the developers. The administrator A specifies rules for the competition. The rules may include the start and end time of the competition, the awards(s) to be offered to the winner(s) of the competition, and the criteria for judging the competition. The administrator and/or sponsor may also select a team of individuals as judges (e.g., one to five people) and select a chief judge. In some cases, the judges may judge all phases of a competition, whereas in other instances the judges may change. For example, if certain individuals are skilled at judging marketing concepts, they may be selected to judge the idea and pitch phases, whereas others may be skilled at judging video content, and be selected to judge the media phase.

There may be prerequisites for registration for participation in the competition. In some cases, the specification may be assigned a difficulty level, or a similar indication of how difficult the administrator, sponsor, or other evaluator of the concept believes it will be to produce the content according to the concept. Once the contest parameters are entered, the administrator A posts the concept (STEP 320) such that members of the community may view and enter the contest. In some instances, messages may be sent to the entire community C, or, in some cases, only select members (e.g., those with a track record of producing quality content, or those in a certain geographic area and/or demographic group).

The communication can occur over a communications network using such media as email, instant message, text message, mobile telephone call, a posting on a web page accessible by a web browser, through a news group, facsimile, or any other suitable communication. In some embodiments, the communication of the concept can be accompanied by an indication of the rules including without limitation timing and the prize, payment, or other recognition that is available to the developers that submit specified content. In some cases, the amount and/or type of payment may change over time, or as the number of participants increases or decreases, and/or as the content is successfully distributed (e.g., viewed or used). In some cases submitters may be rewarded with different amounts, for example a larger reward for the best submission, a smaller reward for second place, an even smaller reward for third place, etc. The number of developers receiving an award can be based on, for example, the number participating in the competition and/or other criteria. Some developers may receive a “bonus” or additional reward based on the “success” of the project, ongoing participation, and so forth. In some examples, the sponsor may have a cash prize that is directly correlated to the number of participants in each round, so, for example the prize money increases with each submission, similar to a progressive slot machine.

The recipients of the concept may be selected in various ways. In some embodiments, members of the community may express interest in participating in a particular type of development competition, whereas in some cases individuals are selected based on previous performances in competitions, prior projects, and/or based on other methods of measuring the technical and/or artistic skill of the members. For example, the members of the community may have been rated according to their performance in a previous competition and the ratings may be used to determine which members are eligible to receive notification of a new contest or respond to a notification. The community members may have taken other steps to qualify for particular competitions, for example, executed a non-disclosure agreement, provided examples of prior work (e.g., an online or hard-copy portfolio) provided evidence of citizenship, submitted to a background check, and so forth. Recipients may need to register for a competition in order to gain access.

In one embodiment, the administrator moderates a collaborative discussion forum among the various participants to answer questions and/or to facilitate development by the developers. The collaborative forum can include such participants as administrators, developers, sponsor(s), and/or others interested in the development of certain content. In one embodiment, the collaboration forum is an online forum where participants can post ideas, questions, suggestions, or other information. In some embodiments, only a subset of the members can post to the forum, for example, participants in a particular competition or on a particular team.

In this example, a first round is held, referred to as the “idea round.” Developers D submit an idea (STEP 325) for the advertisement to compete for cash prizes and to advance in the competition. The idea may be limited in time and/or characters, such as less than fifteen seconds of video or fewer than 144 characters (e.g., a “Twitter-compatible submission). The winning ideas will be the building blocks for subsequent rounds of competition. Accordingly, contestants whose ideas place in the top five, may win a cash prize, and may also receive a percentage of any winnings throughout the contest which are based on their idea.

The administrator, judges, lead judge and/or the sponsor may screen submissions to see if they meet the contest parameters. If a submission fails to meet the contest parameters, it may be disqualified and replaced by the next highest scored submission.

Once the screener indicates that one or more submissions have passed the initial screening process, the judges are notified such that they may then evaluate the submissions in greater detail. Scores and reviews from the judges may be aggregated into a final review and score, which, in some cases can include compiling information contained in one or more review scorecards. Such aggregation can be performed by one or more judges J, or in one exemplary embodiment, the aggregation is performed using a computer-based aggregation system. In some embodiments, the administrator A or a designated review panel member resolves discrepancies or disagreements among the members of the review panel. In addition to reviewing the submissions, the judges J may identify useful modifications to the submission that should be included in the idea prior to final completion. The review panel documents the additional changes, and communicates this information to the developer D who submitted the content.

To determine which idea will be used as the winning idea as a result of the contest, a idea selection and/or review process (STEP 330) is used. A review can take place in any number of ways. In some cases, the administrator A engages one or more members of the community C, the administrator A and/or the sponsor S as judges J. In some embodiments, the review process includes one or more developers acting as a review panel to review submissions from the developers D. A review panel may have a small number of (e.g., fewer than five) members, for example, three members, but can be any number. Generally, the review panel is formed for only one or a small number of related contests, for example three contests which may all be associated with the same sponsor. In some cases, the administrator A acts as the primary judge, who may be responsible for coordination and management of the activities of the panel.

The panel scores the submissions based on criteria as described in the contest parameters. Scoring of the submissions may be accomplished in many possible ways, including qualitative methods, quantitative methods and a combination of the two. For example, the submissions may be based on a placement from first to last (or, in some cases, limited to the top ten placements) and assigned a predetermined point value. In some cases, each judge may rank each submission independently, and the scores from all the judges are summed to arrive at a total score. The five ideas receiving the highest final scores are awarded a cash prize and their idea is posted on the contest web site and advances to the next round of competition.

The ideas (or, in some cases, a single idea) selected as the best ideas and/or having the highest combined scores are selected as the winning ideas (STEP 330). The winning ideas may be used for implementation, production, or for review and input and/or specification for another competition. The winning ideas are then posted (STEP 335) by the administrator to facilitate subsequent phases of the process and competitions in which the ideas may be used as a basis for further development of the desired media content. Prizes, payment and/or recognition (as described in greater detail below) may be awarded to the developer or developers who submit the winning ideas.

A second competition phase is held, referred to as a “pitch phase” to refine and/or build on the idea submissions. Developers create and post pitches (STEP 340) based upon any one of the winning ideas. The pitches may be limited to thirty seconds or less of video, 100 words or 500 characters or less to compete for cash prizes and to advance in the competition. The judging and/or screening of the pitches is similar to the idea round, such that the winning pitches are selected (STEP 345) and posted (STEP 350) for subsequent competitions. For example, the five pitches receiving the highest final scores win a cash prize posted on the contest web site for advancement to the next round of competition. In some embodiments, the ideas on which the winning pitches are based receive a percentage (e.g., 5%) of the total cash payout based on their idea. For example, if a first idea advanced, and another member based their pitch on the first idea, and that pitch won $5,000, the submitter of this first idea receives an additional $250.

A third round is held, referred to as the “media round.” Contestants in this third round submit finished media content (e.g., films) based on any one of the five winning pitches (STEP 355). In some cases, the media files are evaluated, scored and selected (STEP 360) by judges, whereas in other instances the media content may be scored based on a community review and the judges review, with the community score and the judges score resulting in the final score.

The judges select and rank the eligible media files based on the following factors and scoring: (25%) viability of the entry as a premise for the final objective of the contest (e.g., commercial advertisement, music video, how-to-video, etc.); (25%) originality; (25%) creativity; and (25%) effectiveness in promotion of the final objective of the contest. Each judge applies the scoring criteria described above to rank the entries based on the scores, e.g., from 1 (best) to 10 (worst). The entries with the highest combined scores of all the judges are identified as the candidate media entries. The candidate films are posted (STEP 365) on the web site, and they advance to the next round of competition. In one implementation, the ideas that are incorporated in the five winning films each receive 5% of the total cash payout, and pitches that are incorporated in the five winning films each receive 10% of the total cash payout for those films.

After the media round, there may be a fourth round during which input from members of the community is used to predict which entry should be selected as the winning entry. Each community member participating in the prediction phase of a contest views each of the submitted media entries (STEP 370) and selects and ranks (STEP 375) the entries in the order of finish that they predict the judges will select as the top entries, based on the judging criteria described above. In one particular instance, the community members' predicted orders of finish are compared to the judges ranking, and a variance is calculated. In some cases, the placements within the ranking may be weighted such that correctly identifying the top-ranked submission has a greater influence on the variance than correctly guessing the 10^{th}-best submission. The community member(s) whose overall rankings deviate the least from the rankings of the judges (i.e., the lowest weighted variance) are selected as the winner(s) of the prediction phase of a contest. In some cases, the idea incorporated in the most viewed film receives a percentage (e.g., 5%) of the total cash payout for the contest. Likewise, the pitch incorporated in the most viewed film may also receive a percentage (e.g., 10%) of the total cash payout. In some instances, the prediction and most viewed phases of the contest may be applied at the idea, pitch and/or media phase to predict which idea, pitch or media element will be the most successful, generate the most views, or be used in subsequent phases. As a result of the multiple contest steps, a winning media entry is selected (STEP 380) and provided to the sponsor as a completed media project.

For some period of time after the winning entries are announced (e.g., four weeks), the entry that has been viewed the most times online receives an additional cash prize. The developer who submitted most-frequently viewed entry is selected as the “Most Viewed Video Winner.” There can also be prizes, payments, and/or recognition for the developers of the other submissions. For example, the developers that submit the second and/or third best submissions may also receive payment, which in some cases may be less than that of the winning contestant. In some cases, payments and/or additional points may also be awarded for creative use of technology, submitting a unique feature, or other such submissions. In some cases, a sponsor may review and/or use a submission that is not a winner according to the process just described. In such cases, the sponsor may decide to award a prize and thereby acquire a submission even if it was not selected according to the scoring.

Throughout the different contests and phases, the administrator A allocates prizes (e.g., monetary payments, points, etc.) (STEP 385) based on the extent and frequency that a developer's content is used. The distribution of the prize money (STEP 390) may occur during the contests (e.g., with each use and/or win) or be delayed until the delivery of the final winning media element.

It should be understood that the development contest model may be applied to different portions of work that are required for the development of an overall content, and therefore not all competitions necessarily include all the phases described above. A series of development contests is particularly applicable to content in which the development may be divided into stages or portions. It can be beneficial in many cases to size the content developed in a single competition such that work may be completed in several hours or a few days. The less work required to develop a submission, the lower the risk for the contestants that they will not win. For example, reusable content (e.g., templates, graphics, tools, designs, etc.) may be provided to increase the speed of development in each of the various stages.

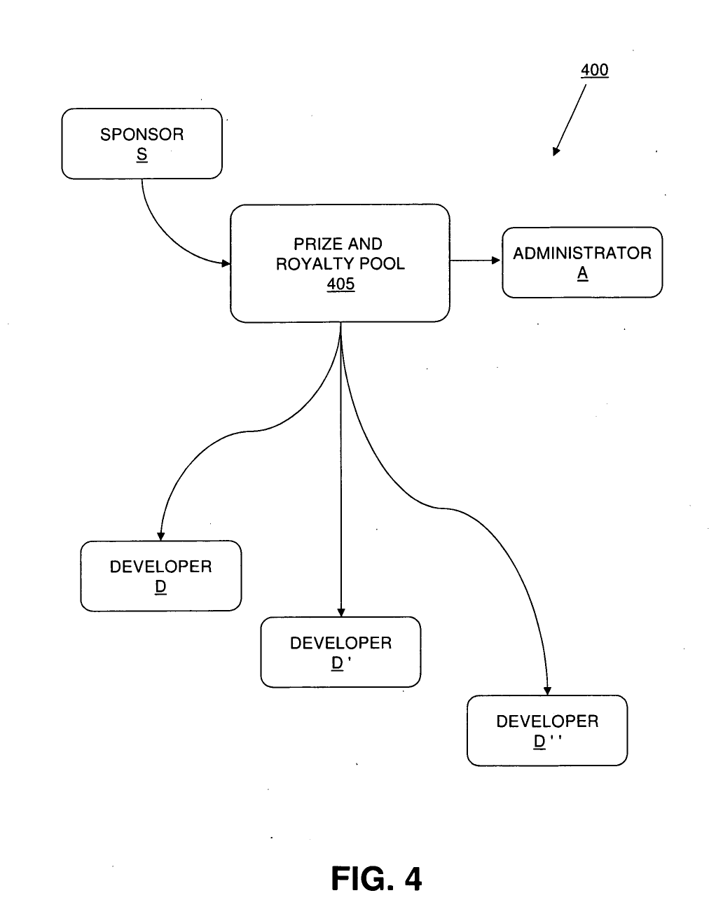

FIG. 4 illustrates, in summary, a process 400 for allocating prize money to developers. The sponsor S allocates a total royalty pool 405 for the developers to be administered by the administrator A. The developers can receive prizes and/or cash based on numerous events during the competitions. For example, the developer submitting a winning idea may be paid for that idea, but may also be paid additional money for each developer that uses her idea for subsequent pitches Likewise, subsequent user's ideas and pitches used to create a final media element may generate additional revenue to the developers.

In one exemplary embodiment, a total prize purse of $100,000 is offered and divided as shown in TABLE 1. There are 4 rounds of prizes as just described—a first round is for submission of a plot idea, a second round is for a pitch, a third round is for a completed media element and the 4^{th} round is for the media element that is viewed the most. In the first round, the top five idea submissions receive $2,500, $1,000, $750, $500, and $250. In the second round, the top five pitch ideas receive $5,000, $2,000, $1,500, $1,000, and $500. In the third round, the top five media submissions receive $25,000, $10,000, $7,500, $5,000, and $2,500. The most viewed film receives a bonus of $25,000. There also may be judge-awarded “bonus” prizes of $500 each.

In this example, idea round and pitch round winners receive 5% of any winnings based on their idea or pitch, however only round 3 winners are eligible for the $25,000 “most viewed” prize.

TABLE 1
Contest Structure - Total Purse $100,000

| | Total | 1st | 2nd | 3rd | 4th | 5th |
|---|---|---|---|---|---|---|
| | Purse | Place | Place | Place | Place | Place |
| Round | $5,000 | $2,500 | $1,000 | $750 | $500 | $250 |
| 1 - | | | | | | |
| Idea¹ | | | | | | |
| Round | $10,000 | $5,000 | $2,000 | $1,500 | $1,000 | $500 |
| 2 - | | | | | | |
| Pitch² | | | | | | |
| Round | $50,000 | $25,000 | $10,000 | $7,500 | $5,000 | $2,500 |
| 3 - | | | | | | |
| Media | | | | | | |
| Element | | | | | | |

| | | |
|---|---|---|
| Round | $25,000 | Given to the film that gets the |
| 4 - | | most number of views online. |
| Most | | |
| Viewed | | |

The judging of each competition round may be by only administrators, judges and/or sponsors, and/or by popular vote of some or all of the members of the community. In some embodiments, film views may also be the only criteria for the prize, or film views may be factored into the judging.

### Example

In one demonstrative example, a series of competitions are held to create a 1 to 3 minute short film that integrates a specific consumer product or brand into a storyline. For the purposes of this example, the starting concept of the contest is to integrate Brand Brewing Co. beer into a short film. The goal of each round of the contests is to create building blocks from which to base subsequent rounds or submissions. In this example, the contestant winning the idea contest is not guaranteed to be a part of the winning film because a number of winners are selected, and each of the contestants in subsequent contests may select from a number of winning building blocks on which to build their story.

For the idea competition, for example, an email is sent to a group of users having requested to receive a notification of a new competition, with information about competition parameters (prize money, general requirements, etc.) and timing. A link to the competition web site may be provided with further information about the starting concept and the competition. Prior to the competition deadline, contestants submit their “idea” of 140 characters or fewer. The judges then rate, rank and/or score the submissions to determine the top five submissions.

At this stage, the client, Brand Brewing Co., now owns five ideas for their product, which have been reviewed by the judging panel. The second competition (the pitch competition) is then started for the development of the storyline. An email alerts a group of users to the new contest, rules and timeline, and to the winning pitches of the pitch competition. The goal of this contest is to outline the storyline for the short film or ad based upon any one of the five winning ideas. The judges' scores are combined to identify the top five pitches, each of which receive a cash prize (in exchange for transfer of rights to the submission) and become the five eligible building blocks for a film competition. At the conclusion of the second competition, Brand Brewing Co. owns five pitches based on fleshed-out ideas for filmed entertainment based on their brand.

For the media competition, an email is sent to a group of users who have requested such notifications that a new competition is going to start, with information about competition parameters (prize money, general requirements, etc.) and timing, and to the winning pitches. Contestants film their version of any one of the five winning “stories” based on the pitch competition and submit the film version by a deadline. The submission may be, for example, an upload of a digital copy of the film, which are reviewed by the judges. In this example, the top five films receive a cash payout. Brand Brewing Company now has five films that include their content, which they can distribute or show in any number of venues.

In this example, the winning idea and pitch on which each of the winning films also receive a bonus, for example, 5% and 10% of the winning payout, respectively. In addition, of the films submitted, whichever gets the most number of views by a certain date receives a percentage of the total cash payout. This provides an incentive for filmmakers to create compelling content.

It should not be overlooked that members of the community can interact with each other during the competitions, discussing various aspects of the product, what it means, how the product it is best used, potential new uses for it. Further, those taking part in the development of the media asset (e.g., directors, producers, writers, actors, etc.) can all collaborate with each other. Brand partners can directly source their consumers for instant demographics, product feedback and how different marketing campaigns and concepts are actually received.

It should be understood that the system described can also be used to develop content of any length (e.g., television-length or feature-length) or type. It is possible, for example, to hold competitions to develop a range of pages in a screenplay, storyboards, set design, advertising material, instructional materials, public service announcements, promotional videos, music videos, musical accompaniment, editing, and casting. The larger and more diverse the skill set in the web site user community, the better the results with respect to the reaction of particular market segments to the brand or product will become.

A significant advantage of this multi-stage, progressive, collaborative contest-based approach is that the imposed deadlines and distribution of labor involved in the creation of filmed content results in the ability to create high quality content in a very short amount of time. The timeline for each contest may be 7 to 14 days. With a 3-stage contest, where each stage takes two weeks, within 6 weeks, a consumer product sponsor can own five creative and compelling films with their product or brand integrated. More importantly, the five films are likely to be, by definition “successful” as a diverse user base and a panel of judges has deemed it such.

Another advantage of this democratic approach to content creation is that it permits collaboration among a highly diverse group of creative developers. A store owner in Iowa with a good concept for a film can collaborate with a film student in New York who is a great editor. Members of this diverse user base can interact with one another on the site, which permits social/professional networking, and permits amateur and professional video creators to interact, showcase their work, critique, and ultimately recruit colleagues to collaborate. Users can also showcase their earnings and their placement in various competitions.

What is claimed is:

1. A system for facilitating the development of a media asset, the system comprising:
a communications server for communicating media asset development contest information to a plurality of developers within a community of developers;
a contest server configured to (i) receive competition parameters, (ii) receive, from the plurality of developers, a plurality of media content elements in response to the communicated media asset development contest information, (iii) facilitate the review of the media content elements, thereby identifying one or more winning media content elements, and (iv) provide the winning media content elements to the community of developers as subject matter for one or more subsequent phases of the contest, a final phase of which results in a completed media asset.

2. The system of claim 1 further comprising a payment module configured to allocate payment to developers submitting the winning media content elements.

3. The system of claim 2 wherein the payment module is further configured to allocate payment to developers based on usage of the media content elements in the subsequent phases of the contest.

4. The system of claim 1 wherein the media asset comprises one or more of a feature film, television show, instructional video, training guide, music video, commercial, print advertisement, web-enabled video advertising, short film, cartoon, illustrated book, graphic novel, graphic design, product/packaging design, unique character, tagline, slogan, marketing and promotional idea, marketing concept, product name and public service announcement.

5. The system of claim 1 wherein the media content element comprises one or more of an idea, a script, a storyline, a media file and a pitch.

6. The system of claim 1 further comprising a voting module configured to (i) present media content elements to members of the community and (ii) receive feedback on the media content elements, the feedback comprising a prediction of how well the media content element will place in the contest.

7. The system of claim 3 wherein the payment module is further configured to allocate payment to members of the community who accurately predict results of the contest.

8. The system of claim 1 further comprising a client device configured to facilitate entry of the media asset development contest information.

9. The system of claim 8 wherein the client device is further configured to facilitate review of the media content elements.

10. The system of claim 1 further comprising a database module for storing the media asset development contest information, the media content elements, and the media assets.

11. A method for developing a media asset, wherein the media asset is based on a plurality of media content elements, the method comprising:
(a) receiving, at a contest server, contest information defining parameters of a media asset creation contest, wherein the media asset creation contest comprises a plurality of contest phases, each resulting in one of the media content elements;
(b) transmitting, from a communications server, the contest information and a media content element;
(c) receiving, via the communications server and in response to the contest information and the first media content element, subsequent contest elements based at least in part on the first media content element;
(d) facilitating, at the contest server, scoring of the subsequent content elements to determine a winning subset of the content elements; and
(e) repeating steps (c) and (d) for each phase of the contest until a completed media asset is determined.

12. The method of claim 11 wherein the contest information is received from a sponsor of the media asset creation contest.

13. The method of claim 12 wherein the contest information and the media creation elements are transmitted to a community of media element developers wherein members of the community are unaffiliated with the sponsor and each other.

14. The method of claim 13 further comprising allocating payment to members of the community based on results of the contest.

15. The method of claim 14 wherein the allocation of payments to members of the community is further based on use of submitted content elements in subsequent phases of the contest.

16. The method of claim 11 wherein the media asset comprises one or more of a feature film, television show, instructional video, training guide, music video, commercial, print advertisement, web-enabled video advertising, short film, cartoon, illustrated book, graphic novel, graphic design, product/packaging design, unique character, tagline, slogan, marketing and promotional idea, marketing concept, product name and public service announcement.

17. The method of claim 11 wherein the media content element comprises one or more of an idea, a script, a storyline, a media file and a pitch.

18. The method of claim 11 further comprising presenting the media content elements to members of the community and receiving feedback on the media content elements, the feedback comprising a prediction of how well the media content element will place in the contest.
